(19) United States
(12) Patent Application Publication
(10) Pub. No.: US 2023/0268782 A1
(43) Pub. Date: Aug. 24, 2023

(54) STATOR FOR A ROTARY ELECTRIC MACHINE

(71) Applicants: NIDEC PSA EMOTORS, CARRIERES SOUS POISSY (FR); SKYAZUR, TOURCOING (FR)

(72) Inventors: Olivier GAS, GOND PONTOUVRE (FR); Xavier JANNOT, ANGOULEME (FR); Jacques SAINT MICHEL, ANGOULEME (FR); Francois TURCAT, MONTIGNAC SUR CHARENTE (FR); Nicolas LANGLARD, LOOS (FR); Sébastien DESURMONT, MARQ-EN-BAROEUL (FR)

(21) Appl. No.: 18/012,134

(22) PCT Filed: Jun. 16, 2021
(86) PCT No.: PCT/FR2021/051085

§ 371 Date: Dec. 21, 2022

(30) Foreign Application Priority Data
Jul. 23, 2020 (FR) 2007746

(51) Int. Cl. H02K 1/16

(52) U.S. Cl. CPC H02K 1/16

(57) ABSTRACT

A stator (2) for a rotary electric machine (1), comprising:—a radially interior ring (25) comprising teeth (23) and slots (21) opening radially towards the outside and extending between the teeth, bridges of material (27) connecting two adjacent teeth to their base and defining the bottoms of the slots between these teeth,—coils (22) arranged in the slots, having electrical conductors arranged in an ordered fashion in the slots (21), and—a radially outer yoke (29) attached in contact with the ring, the yoke being formed of assembled sectors (30).

### CROSS-REFERENCE TO RELATED APPLICATIONS

This application is the US National Stage under 35 USC § 371 of International Application No. PCT/US2021/051085, filed 16 Jun. 2021 which claims priority of French App. No. 2007746 filed on 23 Jul. 2020, the content (text, drawings and claims) of both said applications being incorporated herein by reference.

### BACKGROUND

### Technical Field

The present invention relates to rotary electric machines, and more particularly the stators of such machines.

### Prior Art

In the case of known stators, the yoke houses slots which are entirely open or semi-open in the direction of the air gap, so as to allow for the introduction of coils. In general, the semi-open slots receive electrical conductors which are circular in cross section and are arranged loose, as described for example in the patent application FR 2 801 142, while the entirely open slots house electrical conductors which are rectangular in cross section and are arranged in an ordered fashion.

JP 2 875497 relates to a stator of an electric machine comprising a toothed ring, the sheets of which comprise portions which are thinner in width, located between two consecutive teeth on the side of the air gap. Such thinner portions form openings towards the air gap which may produce non-negligible electromagnetic disturbances, in particular an increase in the “magnetic” air gap on account of flux fringes, higher iron losses at the surface of the rotor for the same reason, or indeed pulsating torques because the variations in permeance are relatively drastic. Furthermore, the coils are coiled there on teeth.

JP 2011-097723 discloses individual teeth attached on a yoke.

The patent application FR 3 019 947 and the International Application WO 2015/155730 describe a stator comprising a toothed ring comprising teeth which are interconnected by bridges of material and define, therebetween, slots for receiving coils, the slots being open radially towards the outside. The openings of the slots are closed by a yoke attached to the toothed ring.

There is a need to benefit from a stator of a rotary electric machine which is simple to assemble, allowing for effective filling of the slots and simple production of the stator, while ensuring satisfactory electromagnetic performance. There is also a need to further improve the stators of electric machines, and in particular to reduce the torque ripples.

### SUMMARYSTATOR

The disclosed stator of a rotary electric machine aims to meet this need, and achieves this, according to one of its aspects, in which the stator comprises:
a radially interior ring comprising teeth and slots opening radially towards the outside and extending between the teeth, bridges of material connecting two adjacent teeth at their base and defining the bottom of the slot between these teeth,
coils arranged in the slots, in particular in a distributed manner, having electrical conductors arranged in an ordered fashion in the slots, and
a radially outer yoke, attached in contact with the ring, the yoke being formed of assembled sectors.

The bridges of material connecting two adjacent teeth at their base and defining the bottom of the slot between these teeth allow for the closure of the slots on the air gap side. The bridges of material and the teeth are formed in one piece with the remainder of the sheets forming the ring. The presence of slots that are closed on the side of the air gap makes it possible to mechanically reinforce the stator and to reduce the vibrations, since a minimized cogging effect (“cogging torque”) is obtained, the electromagnetic disturbances being reduced, or indeed suppressed, compared with a stator of the prior art having slots which are open towards the air gap.

### Yoke

“Attached yoke” is intended to mean that the yoke is not formed in one piece with the ring, but is fixed thereto during the production of the stator.

The yoke is formed of assembled sectors. The sectors of the yoke are not formed in one piece, but assembled together and on the ring during the production of the stator.

The production of the yoke can be facilitated thereby, as can the assembly of the stator.

The sectors of the yoke may each have an angular extent β of between 18 and 180°, preferably between 24 and 120°, indeed between 30 and 90°, being for example of the order of 72°. The angular extent is measured in a transverse plane of the stator, perpendicular to an axis of rotation of the machine, around said axis of rotation. The angular extent is defined between the lateral faces of the sectors, defining the interface between the sectors.

In one embodiment, the sectors of the yoke may each have an angular extent β of 120°, the yoke comprising 3 angular sectors intended to cooperate with 12 slots each. In another embodiment, the sectors of the yoke may each have an angular extent β of 60°, the yoke comprising 6 angular sectors intended to cooperate with 6 slots each.

In yet another embodiment, the sectors of the yoke may each have an angular extent β of 30°, the yoke comprising 12 angular sectors intended to cooperate with 3 slots each.

In one embodiment, all the sectors of the yoke have the same angular extent. In a variant, all the sectors of the yoke are identical. They may be identical with respect to their angular extent, their shape, the arrangement of complementary surface reliefs which allow for the various sheets, making up the yoke, to be clipped together, said list not being limiting.

In one embodiment, a sector of the yoke, indeed all the sectors, may have a certain symmetry, partial or complete, with respect to a plane perpendicular to an axis of rotation of the machine, making it possible to assemble these in one direction or in the other during the production of the yoke. The sectors can thus be “reversable,” for example one layer in two. Such a configuration may make it possible to improve the stiffness of the stator following assembly of the sectors which make up its yoke.

In a variant, a sector, indeed all the sectors, may be symmetrical with respect to a plane perpendicular to an axis of rotation of the machine.

Each sector may comprise a stack of sheets. Each sheet of the stack of sheets may be one-piece. The lamination of the sectors makes it possible to limit the eddy current losses. The sheets may be glued together or stapled together, or indeed welded together.

In one embodiment, a sheet, indeed each sheet, may have a certain symmetry, partial or complete, with respect to a plane perpendicular to an axis of rotation of the machine, making it possible to assemble these in one direction or in the other during the production of the sector. The sheets can thus be “reversable,” for example one in two.

At least two adjacent sheets may be arranged in staggered rows relative to one another. The arrangement in staggered rows may be achieved by reversing some sheets, in particular every other sheet, of the stack of sheets forming the sector, or by angular cutting of the sheets, or by using different sheets. The sheets may be arranged in groups of three sheets arranged in the same direction, stacked on a group of three reversed sheets, and so on.

A sector may, for example, comprise between 10 and 200 sheets, preferably between 15 and 100 sheets, for example between 20 and 50 sheets.

In a variant or in addition, the sheets or groups of sheets may be circumferentially offset. Such a configuration makes it possible to promote the passage of the magnetic flux via the faces of the sheets.

Such a configuration may make it possible to minimize the distance between the assembly surfaces, and to minimize the clearance between the sectors and the ring. The possible barriers to the passage of the magnetic flux are thus minimized.

The sectors of the yoke may be cut from a strip of sheet metal, all in the lamination direction of the strip of sheet metal. Thus, the flux in the yoke may flow through all the sectors, in the lamination direction of the sheet.

The interior ring may be obtained by cutting a narrow strip of sheet metal, then shaping into a ring by deformation of the bridges of material connecting the teeth. The passage of the flux in the sheets is facilitated thereby.

Using relatively narrow strips of sheet metal for the cutting may make it possible to minimize the risk of flaws in the sheet. Furthermore, the influence of possible flaws in the sheet can be minimized insofar as they can be distributed over the entire periphery of the yoke, which may make it possible to minimize the impact on the geometry of the pack of sheets.

It is possible, for example, to use different sheets for the yoke and the ring, for example sheets having different magnetic shades.

The yoke may comprise, in cross section, between 2 and 20 sectors, preferably between 3 and 15 sectors, indeed between 4 and 12 sectors, for example 5 sectors. One or more sectors of the yoke may each have an angular extent allowing them to cooperate with one or more teeth of the ring, in particular a plurality of teeth, in particular at least 2 teeth, indeed at least 3 teeth, for example between 2 and 20 teeth, preferably between 3 and 15 teeth, for example 9 teeth.

Each sector of the yoke may have an angular extent allowing it to cooperate with one or more teeth of the ring, in particular a plurality of teeth, in particular at least 2 teeth, indeed at least 3 teeth, for example between 2 and 20 teeth, preferably between 3 and 15 teeth, for example 9 teeth. The number of teeth with which a sector of the yoke cooperates may be an integer or, in a variant, a non-integer. Each sector of the yoke may cooperate with the same number of teeth.

The sectors may be designed so as to optimize the off-cuts during their cutting. It is possible, for example, to select their angular extent and/or the number of teeth and/or of slots per sector for this purpose.

The sectors may be designed so as to optimize the magnetic flow in the stator. It is possible, for example, to select their angular extent and/or the number of teeth and/or of slots per sector for this purpose.

It is possible, for example, to select the height of the sectors taking into account the thickness of the sheets and the profusion, which is the amount of iron contained in a given length of the stator. The profusion may depend on the thickness of the sheets, the quality of the sheets, possible local flaws in the sheet, lamination or varnishing flaws.

The yoke may be designed such that the sectors thereof can be assembled together by a movement in the radial direction, which is advantageous for facilitating the assembly of the sectors of the yoke.

The sectors of the yoke may comprise reliefs designed to fit into one another, preferably in a radial direction. Said reliefs may be defined such that it is necessary to pass a hard spot during their radial assembly. There may for example be an elastic deformation, there, of the female part of the relief during the radial assembly. Said hard spot may make it possible to keep these sectors against the interior ring during the coiling of the stator, which makes it possible to prevent the addition of dedicated external equipment.

Two adjacent sectors of the yoke may define, therebetween, an interface extending in a substantially radial plane. The interface may extend entirely in said radial plane. Said interface may be planar.

All the sectors of the yoke may define, therebetween, an interface extending in a substantially radial plane. All the interfaces may each extend entirely in a radial plane. Each of said interfaces may be planar.

In a variant, the interface may not be entirely radial, it being possible for one of the sectors to comprise one or more reliefs intended to cooperate with one or more corresponding reliefs of the other adjacent sector. Such reliefs may make it possible to promote the radial immobilization of one yoke sector with respect to the adjacent yoke sector, and to keep the yoke sectors fixed relative to one another, in particular radially as well as circumferentially. In this case, the interface may extend in the radial plane, with the exception of the cooperating relief(s).

The radial plane of the interface may pass through a slot, in particular in the center thereof. Preferably all the radial planes of all the interfaces of the yoke may pass through the slots, in particular in the center thereof. In one embodiment, the radial plane of the interface may pass through a slot, but not in the center thereof but rather offset with respect thereto. The radial plane of the interface may for example pass the slot at ⅓ or at ⅔ thereof, or at ¼ or ¾ thereof. A configuration of this kind makes it possible to break possible symmetry effects which risk creating noise.

In a variant, the radial plane of the interface may pass through a tooth, preferably all the radial planes of all the interfaces of the yoke may pass through teeth. In yet another variant, radial planes of some of the interfaces pass through slots, and other radial planes of other interfaces pass through teeth.

One or more of the sectors of the yoke may each have a height of between 5 and 50 mm, preferably between 10 and 30 mm, being for example of the order of 15 mm. The total height of the yoke measured along the longitudinal axis X may be an integer multiple of the height of a sector of the yoke.

The stator may comprise an axial stack of sectors which are assembled axially. In one embodiment, a plurality of consecutive sectors are encountered when moving in parallel with the axis of rotation of the machine.

A first interface defined between two adjacent sectors located at a first abscissa along the axis of rotation of the machine may be angularly offset with respect to a second interface defined between two adjacent sectors located at a second abscissa along the axis of rotation, which abscissa is different from the first abscissa.

The angular offset may be between one and ten teeth, preferably between two and eight teeth, for example five teeth. In some embodiments it may be four teeth, or six teeth, for example.

In a variant, the second interface is located circumferentially between the first interface and a third interface located at the same first abscissa. The arrangement of interfaces “located circumferentially between” is defined when the stator is viewed in cross section, from the axis of rotation of the machine.

The sectors of the yoke may comprise surface reliefs which make it possible to clip them together. In one embodiment, each sector comprises a stack of sheets. Each sheet may comprise one or more reliefs on the surface, which reliefs make it possible to clip together the different sheets making up said sector of the yoke.

### Yoke—Ring Interface

The interface between the yoke and the ring may be smooth. It may be of a cylindrical revolution shape.

In a variant, the ring and the yoke may comprise, respectively, first and second reliefs which cooperate with one another and/or with one or more inserts. The first and second reliefs are preferably complementary, and they cooperate in a form-fitting manner. They make it possible to angularly immobilize the yoke with respect to the ring, and to hold the yoke and the ring fixed relative to one another, in particular circumferentially as well as preferably radially. It is possible to achieve stiffening of the ring by the yoke, which may make it possible to form the ring having thin bridges of material, which has several advantages, as set out below. Such a configuration makes it possible to minimize the parasitic air gap between the yoke and the ring.

The presence of first and second reliefs also makes it possible to increase the surface of the interface between the ring and the yoke, and thus to better distribute the flux flowing in the parasitic air gap between the yoke and the ring, and thus to minimize the impact of said parasitic air on the magnetic pole.

The sectors of the yoke may be designed to allow the yoke to exert a mechanical stress on the ring, in order to promote the contact between the yoke and the teeth. There may be a clearance between the sectors, which may be as small as possible, but is preferably always positive.

The cooperation between the first and second reliefs and/or with the insert or inserts may be complete or partial. In other words, their respective shape cannot be exactly the same. The shapes of the first and second reliefs may not be exactly complementary.

The first reliefs of the ring may be arranged on the teeth, in particular at the end thereof facing the yoke. The second reliefs of the yoke may be arranged on the interior surface of the yoke, opposite the teeth of the ring and more particularly opposite the first reliefs. They are in particular angularly offset with respect to the slots of the ring.

The second reliefs may have a contour formed of two straight portions forming an angle α therebetween, connected by a clipping at the bottom of the second relief. The angle α may define the angular opening of the second relief.

In one embodiment, the second relief is oriented towards the yoke. The angular opening α may be given by the following inequality, linked to the angular extent β of the sector:

α≥β−360/Nenc,

where Nenc is the total number of slots of the stator.

The orientation of the second relief towards the yoke may make it possible to facilitate the insertion of coils, by virtue of the absence of a sharp edge at the entrance of the slots.

In another embodiment, the second relief is oriented towards the air gap. The angular opening α may be given by the following inequality, linked to the angular extent β of the sector:

α≥−(β−360/Nenc),

where Nenc is the total number of slots of the stator.

The orientation of the second relief towards the air gap may make it possible to optimize the cutting of sheets from a strip of sheet metal.

In another embodiment, the second relief is flat. The angular opening α may be given by the following equality:

α=180°.

Such a configuration is particularly advantageous for small machines.

In a general manner, the angular opening α may be linked to the angular extent β of the sector by the following formula:

−β>α>β,

where β is the angular extent of a sector of the yoke.

The value of the angular opening α may have a maximum value αmax defined by

αmax=90+360/Nenc,

where Nenc is the total number of slots of the stator.

In one embodiment, the sectors of the yoke may each have an angular extent β of 120°, the yoke comprising 3 angular sectors intended to cooperate with 12 slots each. It is thus possible to have α=60°.

In another embodiment, the sectors of the yoke may each have an angular extent β of 60°, the yoke comprising 6 angular sectors intended to cooperate with 6 slots each. It is thus possible to have α=30°.

In yet another embodiment, the sectors of the yoke may each have an angular extent β of 30°, the yoke comprising 12 angular sectors intended to cooperate with 3 slots each. It is thus possible to have α=15°.

In a variant, the second reliefs may have a contour formed of two straight portions forming an angle α therebetween, comprising, on either side, two flat portions at 180°. A point is thus formed for stopping the rotation of the yoke relative to the ring. The angle α may be given by the formulas above. Such a configuration makes it possible to minimize the disturbances in the flow of the flux between the yoke and the teeth. The height of the point may be selected depending on the maximum torque to be transmitted by the machine. The point may be oriented towards the yoke, or, in a variant, towards the air gap.

In a variant, the second reliefs may have a contour in the shape of a circular arc. The circular arc may have a chord separated by a distance h from its center of curvature. The following relationship is possible:

|N|≥r·sin(β/2−π/Nenc),

where r is the radius of curvature of the circular arc portion, h is the distance separating the chord of the circular arc from the center of curvature, β is the angular extent of a sector of the yoke, and Nenc is the total number of slots of the stator.

In the case where the first and second reliefs have an edge that is defined at least in part by a circular portion, the gap between the radii of the circular portions defining the respective edges of the first and second reliefs may be between 2 and 20 hundredths of a millimeter, preferably between 3 and 15, indeed between 4 and 10 hundredths of a millimeter.

The slots of the ring may comprise rounded angles close to the yoke.

The yoke may comprise notches in the region of the ends of the slots of the ring, close to the yoke. Said notches may make it possible to form rounded angles in the slots of the ring, in the vicinity of the yoke, having a clean cut and without any burrs.

The first and/or the second reliefs may be in the shape of a disk portion which can in particular extend over an angular extent of approximately 180°, or over an angular extent of more than 180°, preferably more than 210°, indeed more than 240°. The other of the first and/or second reliefs thus has a recess shape which is in the shape of a disk portion, of corresponding shape.

In one embodiment, the first and second reliefs may each assume, alternatively, a shape of a disk portion or a recess in the shape of a disk portion, when moving around the axis of rotation of the machine. Said disk portion or the corresponding recess may extend over an angular extent of approximately 180°, or over an angular extent of more than 180°, preferably more than 210°, indeed more than 240°.

In a variant, all the first reliefs project into the recesses of the second reliefs. In such an embodiment, the first reliefs are in the shape of a disk portion, and the second reliefs are in the shape of a recess in the shape of a disk portion.

The second reliefs may be in the shape of a recess in which the ends of the teeth are arranged. In this case, the ends of the teeth form the first reliefs of the ring. The recess may be of a width which is substantially equal to, in particular slightly greater than, the width of the teeth in the region of their free end. The free ends of the teeth may be slightly beveled, so as to promote their insertion into the recesses of the yoke. In the region of the free ends of the teeth, the edges of the teeth may converge slightly with distance from the axis of rotation of the machine.

The first and second reliefs may be designed such that the interface between the ring and the yoke has a rippled shape.

Holes may be arranged at the interface between the ring and the yoke. These holes may serve for passage of a flow of cooling fluid, for example a flow of air, for the cooling of the stator. In a variant, they may serve for passage of tie rods for holding the stator.

### Bridges of Material

The teeth arranged between the slots are interconnected on the side of the air gap by bridges of material. Thus, each slot is closed on the side of the air gap by a bridge of material interconnecting two consecutive teeth of the stator mass. The bridges of material each connect two adjacent teeth at their base, on the side of the air gap, and define the bottom of the slot between these teeth.

The bridges of material are formed in one piece with the adjacent teeth.

The absence of an opening of the slots towards the air gap makes it possible to avoid the production of electromagnetic disturbances, in particular an increase in the “magnetic” air gap on account of flux fringes, higher iron losses at the surface of the rotor for the same reason, or indeed pulsating torques. The electromagnetic performance of the machine is improved thereby.

Moreover, the presence of bridges of material reduces the risk of loss of varnish in the air gap during impregnation of the complete stator with varnish. This makes it possible to reduce the need for cleaning.

It also makes it possible to reduce the leakage of varnish into the air gap during the operation of the machine on which the stator is mounted. This simplifies the maintenance of the machine.

In this case, the term “varnish” should be understood in a broad sense, and covers any type of impregnation material, in particular polymer.

On account of the fact that the slots are closed following assembly of the yoke, the risk of leakage of impregnation varnish towards the air gap is eliminated. The stator may be used as a closed impregnation chamber, by ensuring tightness at the ends of the stator only. The tooling is thus simplified. This also reduces the amount of varnish lost, and the cleaning operations.

### Zone Having Reduced Magnetic Permeability

The bridges of material may comprise zones which are magnetically saturated during the operation of the machine. The passage of the flux from one slot to the other is thus limited, without, however, preventing the passage of the flux from the rotor towards the stator.

In order to achieve the saturation, the bridges of material comprise, for example, zones of smaller width. It is possible to locally reduce the cross section of the bridge of material available for the passage of the flux, for example by providing at least one localized narrowing formed by at least one groove.

At least some, and preferably all, the bridges of material may each have at least one zone having a reduced magnetic permeability, provided in one or more of the following forms:
at least one localized narrowing formed by at least one groove extending in the longitudinal axis of the stator, in the thickness of the bridge of material, or at least one localized crushed portion of the material in the width of the bridge of material, and/or
at least one opening in the width of the bridge of material, and/or
at least one treatment, in particular localized, in the width of the bridge of material, locally reducing the magnetic permeability of the bridge of material.

The zone of reduced magnetic permeability formed by the localized narrowing, the localized crushed portion, the opening, or the localized treatment of the bridge of material makes it possible for said zone of the bridge of material to be magnetically saturated during the operation of the machine, which limits the passage of the flux and increases the effectiveness of the machine.

Each zone of reduced magnetic permeability preferably extends over the entire thickness of the ring. In a variant, the zone of reduced magnetic permeability extends over a length that is less than or equal to the thickness of the ring.

The zone of reduced magnetic permeability of each bridge of material is preferably continuous in the thickness of the ring, straight or otherwise.

In a variant, the zone of reduced magnetic permeability is discontinuous in the thickness of the ring.

For example, the ring is in the form of stacked sheets, each sheet having teeth which are interconnected at their base, on the side of the air gap, by bridges of material, at least some, and preferably all, of the bridges of material each having at least one zone having a reduced magnetic permeability. The zones of reduced magnetic permeability of the bridges of material of each of the sheets may be non-central. Each sheet of the stack of sheets may be one-piece.

At least two adjacent sheets may have at least two zones of reduced magnetic permeability arranged in staggered rows relative to one another, overlapping one another in part, or not. The arrangement in staggered rows may be achieved by reversing some sheets, in particular one sheet out of two, of the stack of sheets forming the ring, or by angular cutting of the sheets, or by using different sheets.

Each sheet is for example cut from a magnetic steel sheet, for example steel of 0.1 to 1.5 mm thickness. The sheets may be coated with an electrically insulating varnish on their opposite faces before their assembly within the stack. The electrical insulation may also be obtained by heat treatment of the sheets, if applicable.

Preferably, in the case where the bottom of the slots comprises at least one groove, the grooves are open towards the slots. The bottom of the slots preferably comprises at least one bearing surface, preferably at least two bearing surfaces, oriented transversely, and the bottom of the groove is set back with respect to said surface or surfaces. The bearing surface or surfaces may be oriented obliquely with respect to the radial axis of the corresponding slot, or, preferably, oriented perpendicularly to said axis. The groove forms a sudden change in gradient with respect to the bearing surface or surfaces. The coils, preferably having a substantially rectangular cross section, inserted into the corresponding slot, preferably bear against the bearing surfaces and are set back with respect to the bottom of the groove. The coils are preferably not in contact with the groove. The bearing surface or surfaces are preferably planar. The bottom of the slot may be flat, with the exception of the groove. This allows for good filling of the slots by the coils in the case of coils having a rectangular cross section, while allowing the coils to bear flat against the bottom of the slots.

The groove in the bottom of the slot preferably forms a clearance between the bridge of material and the corresponding coil, which may facilitate the penetration of the varnish during impregnation of the stator.

The bridge of material may comprise at least two grooves, as described above. The groove or grooves may or may not be centered relative to the slot.

The inner surface of the stator is preferably cylindrical in revolution.

In a variant, the grooves may extend over the inner surface of the stator.

The grooves preferably each have a profile which is curved in cross section, in a plane perpendicular to the axis of the stator, in particular a substantially semicircular cross section.

The localized crushed portion may be formed in the thickness of the bridge of material, i.e. according to a radial axis of the stator, and forms a localized narrowing having a reduced magnetic permeability. The crushed portion preferably forms a groove in the bottom of the slot. In this case, the localized crushed portion may be as described above for the grooves.

In a variant, the localized crushed portion is formed in the thickness of the stator, i.e. according to an axis in parallel with the longitudinal axis of the stator, and has a reduced magnetic permeability.

The above-mentioned opening preferably extends in the longitudinal axis of the stator, over the entire thickness of the stator mass. The opening may have a cross section that is oval or circular, or polygonal in shape, and in particular, rectangular, and can, for example have rounded edges. The bridge of material may comprise just one single opening in its width. The opening may be in the center of the bridge of material. The opening may comprise two thinned zones on either side thereof, the thinned zones being magnetically saturated during the operation of the machine.

In a variant, the bridge of material comprises a plurality of microperforations over its width. The microperforations reduce the cross section of the sheet, and allow the bridge of material to be magnetically saturated for a smaller magnetic flux.

The localized treatment makes it possible to locally modify the permeability of the material of the bridge to the magnetic flux. The localized treatment may extend over the entire width of the bridge of material, or over just a portion thereof. Said treatment may be heat treatment which locally modifies the orientation of the grains of metal, and brings about a reduction in the magnetic permeability in the circumferential direction.

In a variant, the heat treatment is a thermal stress associated with the deterioration of the material during the laser cutting of the bridge of material.

The bridges of material may be dimensionally stable. This increases the rigidity of the stator and improves the service life of the electric machine.

### Slots

The fact that the slots are open radially towards the outside allows for the coils to be inserted into the slots by means of a radial displacement towards the inside of the slots. The installation of the coils is facilitated, on the one hand in that the access to the interior of the slots is easier, these being slots that are entirely open and towards the outside rather than towards the air gap, and on the other hand in that the space available around the ring, for the necessary tools, indeed for a coiling machine, is much larger than the space available in the bore of the stator. Such a configuration is particularly advantageous for small-diameter stators.

Furthermore, such a stator has numerous advantages from the electromagnetic perspective, compared with a stator comprising slots that are open towards the air gap. It makes it possible to significantly reduce the electromagnetic disturbances associated with the presence of openings of the slots facing towards the air gap, in the prior art. Furthermore, since the filling of the slots is facilitated, the rate of filling can be improved, which may make it possible to further increase the performance of the machine. The volume torque can be increased.

The absence of an opening of the slots towards the air gap makes it possible to reduce the slot pulsations. The electromagnetic performance of the machine is improved thereby.

At least one slot may comprise mutually parallel opposing edges, preferably all the slots. An improved rate of filling of the slots is thus achieved. The width of the slots is preferably substantially constant over its entire height.

In a variant, at least one slot may comprise non-parallel opposing edges, for example edges which converge towards the axis of rotation of the machine.

At least one tooth, preferably all the teeth, may be generally trapezoidal in shape when viewed in cross section in a plane perpendicular to the axis of the stator. At least one tooth, preferably all the teeth, may have edges which diverge with distance from the axis of rotation of the machine. Such a configuration may make it possible to compensate the obstacles to the passage of the magnetic flux, which may be associated with the presence of the first and second reliefs cooperating with one another and/or with inserts, a possible opening, or the presence of a parasitic air gap at the interface between the yoke and the ring. The smallest width of the tooth may be substantially equal to the size of the interface between the yoke and the ring for which there is tight contact, i.e. outside of the first and second reliefs cooperating with one another and/or with inserts, or a possible orifice.

The ring may be formed by helically winding a strip of sheet metal comprising teeth formed by the bridges of material, the opposite edges of each slot preferably becoming substantially mutually parallel when the strip is wound on itself to form the ring.

In a variant, the strip may be formed of sectors each comprising a plurality of teeth, the sectors being connected by links, said sectors being cut from a strip of sheet metal. The links may be flexible bridges interconnecting the sectors, and/or parts having complementary shapes, for example of the dovetail mortise and tenon type, or complementary reliefs which come to bear against one another, in particular when the ring is held in compression by the yoke.

The strip or strips of sheet metal may be cut straight, then curved.

The complementary shapes may be on the bridges of material such that the different sectors are assembled in the region of the bridges of material. Preferably, the assembly of complementary shapes of different sectors is performed outside of the deformable zones of the bridges of material. This facilitates the assembly, in particular in the case of large-volume machines.

For example, sectors have hollow shapes cooperating with complementary projecting shapes of adjacent sectors.

In a variant, the ring comprises a stack of pre-cut magnetic sheets.

In a further variant, the ring is produced by additive manufacture, for example by powder sintering, or wafers obtained by additive manufacture, for example by powder sintering.

The yoke is attached on the ring after installation of the coils in the slots, or, if applicable, at the same time.

### Coils

The coils may be arranged in a concentrated or distributed manner in the slots.

“Concentrated” means that the coils are each wound around a single tooth.

“Distributed” means that at least one of the coils passes successively into two non-adjacent slots.

The coils are preferably arranged in the slots in a distributed manner, in particular when the number of poles of the rotor is less than or equal to 8.

The coils each comprise at least one electrical conductor which may, in cross section, be circular in shape, or polygonal in shape having rounded edges, preferably rectangular in shape, said list not being limiting.

The coils may each comprise at least one electrical conductor which is rectangular in cross section, the coils in particular being arranged in a distributed manner in the slots.

When the conductors are circular in cross section, they may be arranged in the slot according to a hexagonal stack. When the conductors are polygonal in cross section, they may be arranged in the slot in one or more radially oriented rows. The optimization of the stack may make it possible to arrange a larger number of electrical conductors in the slots, and thus to obtain a stator having a higher power, at a constant volume.

The electrical conductors may be arranged in a random manner in the slots, or ordered. The electrical conductors are preferably ordered in the slots. “Ordered” means that the conductors are not arranged loose in the slots but rather in an ordered manner. They are stacked in the slots in a non-random manner, being for example arranged according to one or more rows of aligned electrical conductors, in particular according to one or two rows, preferably according to a single row.

### Insulators

The electrical conductors are preferably electrically insulated from the outside by an insulating coating, in particular an enamel coating.

The coils may be separated from the walls of the slot by an insulator, in particular by at least one insulating sheet. Such an insulating sheet allows for better insulation of the coils with respect to the slot.

During insertion of the coils into the slots, which is performed radially and not axially, the conductors move upon contact with a length of the stator which corresponds, at a maximum, to the depth of the slot. This results in reduced mechanical stresses compared with axial insertion, where the conductors are exposed to a movement upon contact with the stator mass over a length equal to the axial dimension thereof.

Preferably, each slot receives at least two coils, in particular at least two coils having different phases, or, in a variant, the same phase. These two coils may overlap radially. The two coils may be separated from one another by at least one insulating sheet, preferably by at least two insulating sheets.

In a variant, the coils are in the form of pins.

Each coil may be formed of a plurality of turns.

In a variant, the coils are said to be in the form of pins, in particular pins in the shape of a U (“U-pin”) or straight, in the form of an I (“I-pin”), and in this case comprise an I-shaped or U-shaped portion, the ends of which are welded to conductors outside of the corresponding slot.

### Machine and Rotor

Also disclosed is a rotary electric machine, such as a synchronous motor or a synchronous generator, comprising a stator as defined above. The machine may be synchronous or asynchronous. The machine may be a reluctance machine. It may form a synchronous motor.

The rotary electric machine may comprise a rotor. The rotor may be a wound rotor or a rotor comprising permanent magnets. In the case where the machine is intended to function as an alternator, the rotor may be wound. In the case where the machine is intended to function as a motor, the rotor may comprise permanent magnets.

During the production of the machine, the rotor may be connected to the ring of the stator, in particular by material connections making it possible to rigidify the ring of the stator during the coiling. After the coiling, indeed after the installation of the yoke of the stator, said material connections are cut so as to allow for the rotation of the rotor with respect to the stator and the use of the machine. The cutting may be performed using an electron beam.

The material connections may be arranged in the region of the teeth of the stator, for example one tooth in two.

The machine may be of a relatively large size. The diameter of the rotor may be more than 50 mm, preferably more than 80 mm, being for example between 80 and 500 mm.

The rotor may comprise a rotor mass extending in the axis of rotation and arranged around a shaft. The shaft may comprise torque transmission means for causing the rotor mass to rotate.

The rotor may or may not be mounted in a cantilevered manner.

The rotor may be formed of a plurality of rotor pieces, aligned in the axial direction, for example three pieces. Each of the pieces may be angularly offset relative to the adjacent pieces (“step skew”). The rotor may be twisted.

### Production Method and Machine

Additionally a method is disclosed for producing a stator as defined above, in which sectors are attached radially on the ring to form the yoke in contact with the ring.

In one embodiment, all the sectors may be attached radially simultaneously.

The sectors may be radially attached to the ring in a radial direction extending in the mid-plane of the corresponding sector.

The fact of radially attaching the sectors of the yoke on the ring makes it possible to reduce the risk of damaging the coils.

It is possible to implement a step of insertion of the coils into the slots of the ring of the stator. During said step, it is possible to arrange at least one coil in two different non-consecutive slots of the ring of the stator. Said step may be performed before the step during which sectors are attached radially on the ring to form the yoke in contact with the ring.

The method may comprise a step of deformation of the deformable zone or zones during mounting of the yoke on the ring and/or the insertion of the coils into the slots. Such a deformation may change the diameter of the ring and the width of the slots.

The step of inserting the coils into the slots can be implemented so as to widen the slots by extension of the bridges of material. This also brings about an increase in the outside diameter of the ring. This facilitates the insertion of the coils.

The coils are preferably inserted into the slots by means of a radial displacement towards the inside, the slots being open radially towards the outside.

The step of mounting the yoke on the ring may cause a reduction in the inside diameter of the ring by constriction of the bridges of material. This makes it possible to assemble the yoke and the ring while having minimal clearance therebetween, in order to improve the electrical performance by reducing the sum of the air gaps of the magnetic pole.

It is possible to assemble the ring and the yoke so as to cause the first and second reliefs to cooperate.

In particular in the case where the bridges of material do not comprise a deformable zone, it is possible, in a variant, to expand the yoke by heating, or contract the ring by cooling, in order to facilitate the assembly of the yoke onto the ring.

### BRIEF DESCRIPTION OF THE DRAWINGS

The claimed invention will be better understood upon reading the following detailed description of non-limiting embodiments thereof, and upon studying the accompanying drawing, in which:

FIG. 1 is a partial schematic perspective view of a stator,

FIG. 2 is a partial schematic perspective view of the ring of the stator of FIG. 1,

FIG. 3 is a detailed view thereof,

FIG. 4 is a partial schematic cross-sectional view of a machine comprising the stator of FIG. 1,

FIG. 5 is a schematic view of a portion of the ring of said stator,

FIG. 6 is a schematic perspective view of a variant of the machine,

FIG. 6a is a detailed view thereof,

FIG. 7a is a view analogous to FIGS. 6 and 6a, of a variant,

FIG. 7b is a view analogous to FIGS. 6 and 6a, of a variant,

FIG. 7c is a view analogous to FIGS. 6 and 6a, of a variant,

FIG. 7d is a view analogous to FIGS. 6 and 6a, of a variant,

FIG. 8 is a schematic view of a variant of the machine,

FIG. 9 is a detailed view thereof,

FIG. 9a is a view analogous to FIG. 9, of a variant,

FIG. 10 is a partial schematic cross-sectional view of a sector of the yoke of FIG. 8,

FIG. 11 is a view analogous to FIG. 10, of a variant,

FIG. 12 is a view analogous to FIG. 10, of a variant,

FIG. 13 is a view analogous to FIG. 9, of a variant,

FIG. 14 is a view analogous to FIG. 8, of a variant,

FIG. 15 is a view analogous to FIG. 9, of the variant of FIG. 14,

FIG. 16a is a view analogous to FIG. 10, of a variant,

FIG. 16b is a partial schematic perspective view of the ring associated with the yoke sector of FIG. 16a,

FIG. 17a is a view analogous to FIG. 9, of another variant,

FIG. 17b is a view analogous to FIG. 9, of another variant,

FIG. 17c is a view analogous to FIG. 9, of another variant,

FIG. 17d is a view analogous to FIG. 9, of another variant,

FIG. 17e is a view analogous to FIG. 9, of another variant.

### DETAILED DESCRIPTION

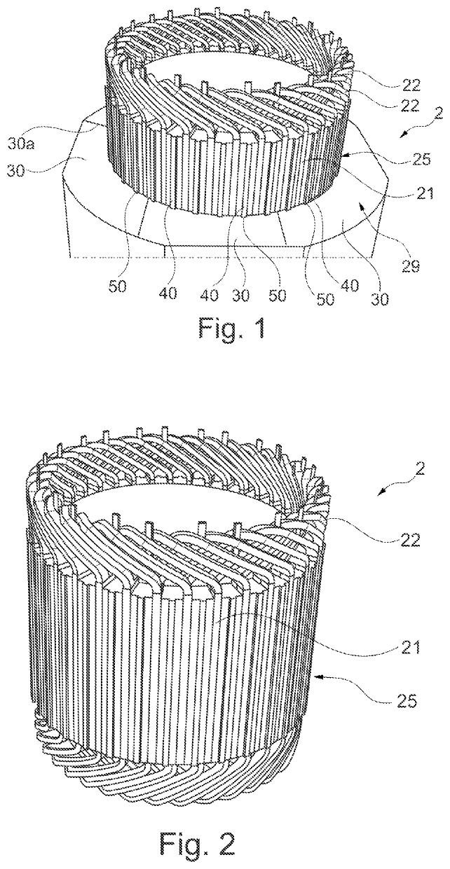

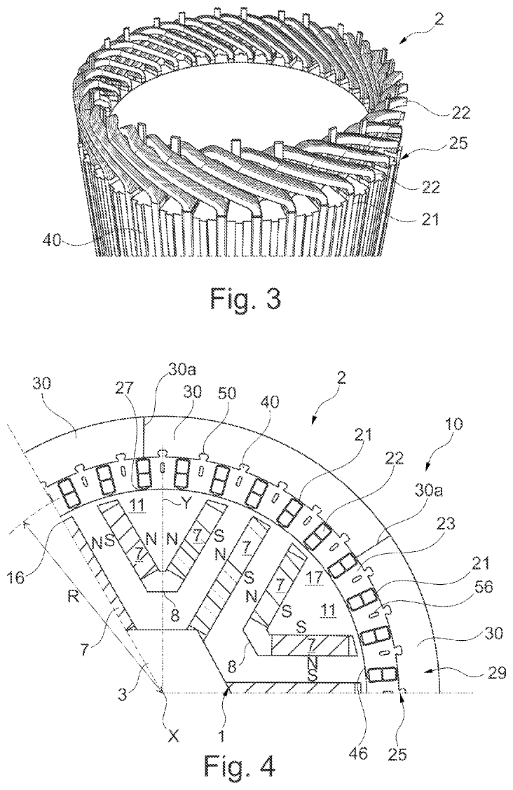

FIGS. 1 to 5 show a rotary electric machine 10 comprising a rotor 1 and a stator 2. The stator 2 makes it possible to generate a rotating magnetic field for causing the rotor 1 to rotate, in the context of a synchronous motor, and in the case of an alternator the rotation of said rotor induces an electromotive force in the coils of the stator.

The examples illustrated below are schematic, and the relative dimensions are not necessarily respected.

The stator 2 comprises coils 22, which are arranged in slots 21 provided between teeth 23 of a radially interior toothed ring 25. The slots are open radially towards the outside and closed on the side of the air gap by bridges 27 of material, each connecting two adjacent teeth of the ring 25 and defining the bottom of the slot between these teeth.

In the example described, the slots 21 have mutually parallel radial edges 33 and are substantially rectangular in shape in a cross section in a plane perpendicular to the axis of rotation X of the machine.

The stator 2 comprises a radially outer yoke 29 and is attached in contact with the ring 25. The ring 25 and the yoke 29 are each formed of a pack of magnetic sheets stacked along the X axis, the sheets being for example identical and exactly superposed. They can be held together by clipping, by rivets, by tie rods, by welds, and/or any other technique. The magnetic sheets are preferably made of magnetic steel.

The yoke 29 is formed of assembled sectors 30, of which there are six in the example described. Each sector 30 is attached in contact with the ring 25. They are assembled together and on the ring during the production of the stator.

In the example described, each sector has an angular extent of 60°, measured in a transverse plane of the stator, perpendicular to an axis of rotation of the machine, around said axis of rotation. Each sector 30 has the same angular extent.

The sectors 30 of the yoke are also identical to one another in shape.

Each sector cooperates with six teeth of the ring 25.

Finally, in the example described, two adjacent sectors 30 of the yoke define, therebetween, an interface 30a extending entirely in a radial plane. Said interface 30a is planar.

The radial planes of the interfaces 30a pass through the corresponding slots, in particular in the center thereof.

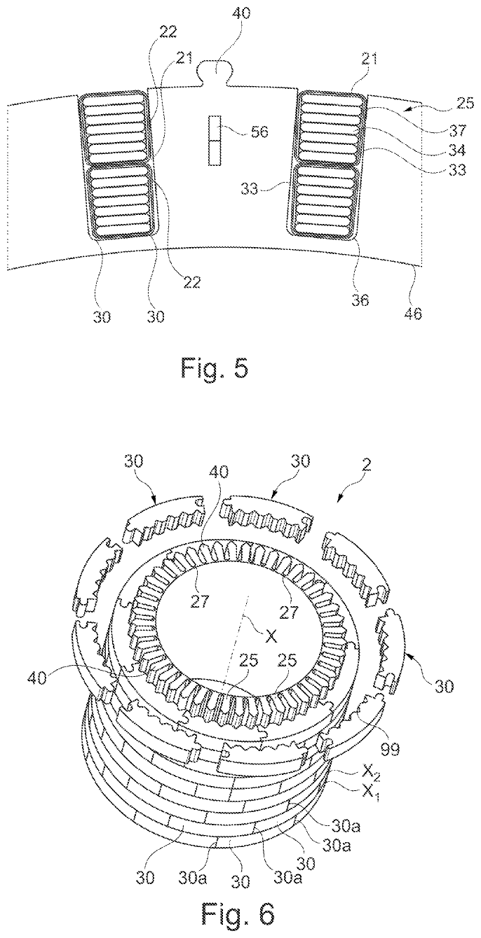

Furthermore, in the example shown, the teeth 23 of the ring 25 comprise complementary surface reliefs 56 which make it possible to clip together the different sheets which make up the ring 25, as can be seen in FIG. 5.

The ring may furthermore be formed of a strip of sheet metal that is coiled up on itself.

The yoke 29 is mounted interlockingly on the ring 25, more particularly the sectors 30 of the yoke 29 are mounted interlockingly on the ring 25. For this purpose, the ring 25 and the yoke 29 comprise, respectively, first 40 and second 50 reliefs which cooperate so as to immobilize the yoke 29 with respect to the ring 25. Said first 40 and second 50 reliefs allow for angular and radial immobilization.

The first reliefs 40 are located on the outer surface of the ring 25, being arranged on the teeth, at the end thereof facing the yoke.

The second reliefs 50 are located on the inner surface of the yoke 29, opposite the teeth of the ring and more particularly opposite the first reliefs. They are angularly offset with respect to the slots of the ring.

The first 40 and second 50 reliefs are complementary and cooperate interlockingly and so as to keep the ring and the yoke in position relative to one another.

The coils 22 may be arranged in a concentrated or distributed manner in the slots 21, preferably in a distributed manner. As shown in FIG. 5, the electrical conductors 34 of the coil 22 are arranged in the slots in an ordered fashion. The electrical conductors 34 preferably have a flattened, rectangular cross section, and are radially superposed for example in a single row. The electrical conductors 34 are enameled or coated with any other suitable insulating coating.

Each slot 21 can receive two stacked coils 22 of different phases. Each coil 22 may be substantially rectangular in shape, in cross section.

Each coil 22 is surrounded by an insulating sheet 37 which makes it possible to insulate the coils from the walls 33 and 36 of the slot and the coils 22 of different phases.

The electrical conductors 34 are assembled in coils 22 outside the slots 21 and surrounded by an insulating sheet 37 and the coils 22 comprising the insulating sheets 37 are inserted into the slots 21. This operation is facilitated by the fact that the slots are entirely open radially towards the outside.

The rotor 1 shown in FIG. 4 comprises a central opening 5 for mounting on a shaft, and comprises a magnetic rotor mass 3 extending axially in the axis of rotation X of the rotor, said rotor mass being formed for example by a pack of magnetic sheets stacked according to the X axis, the sheets being for example identical and exactly superposed. The rotor 1 comprises, for example, a plurality of permanent magnets 7 arranged in the recesses 8 of the magnetic rotor mass 3. In a variant, the rotor is coiled.

The stator may be obtained by means of the production method which will now be described. The coils 22 are first inserted into the slots 21 of the ring 25 by a radial displacement of the coils 21 towards the inside of the slots 21. In a following step, the yoke 29 is attached by force to the ring 27, all the sectors 30 being radially attached simultaneously, in a radial direction extending in the mid-plane of the corresponding sector. Each sector may be inserted onto the ring by axial displacement of one relative to the other, as shown in FIG. 1.

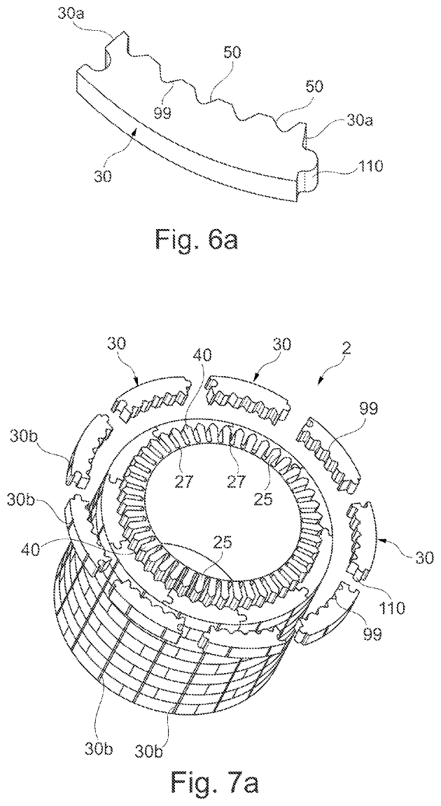

In a variant shown in FIGS. 6 and 6a, the interface between the yoke and the ring forms undulations 99. For this purpose, the first reliefs 40 are in the shape of a boss, and the second reliefs 50 are in the shape of a corresponding recess. In the example described, the second reliefs 50 have an angular opening α of the order of 80°.

In the example described, each sector has the same angular extent, measured in a transverse plane of the stator, perpendicular to an axis of rotation of the machine, around said axis of rotation, allowing it to cooperate with five teeth of the ring. In this example, the yoke 29 comprises nine sectors 30 which are also identical to one another in shape. Each sector cooperates with five teeth of the ring 25.

Two adjacent sectors of the yoke define, therebetween, an interface extending in part in a substantially radial plane, but not entirely, the sectors comprising reliefs 110 intended to cooperate with corresponding reliefs of the other adjacent sector.

In this example of FIG. 6, the stator comprises an axial stack of sectors 30 which are assembled axially. A plurality of consecutive sectors are encountered when moving in parallel with the axis of rotation X of the machine.

A first interface 30a defined between two adjacent sectors 30 located at a first abscissa X1 along the axis of rotation of the machine may be angularly offset with respect to a second interface 30a defined between two adjacent sectors 30 located at a second abscissa X2 along the axis of rotation, which abscissa is different from the first abscissa X1. Furthermore, said second interface 30a is located circumferentially between the first interface 30a and a third interface 30a located at the same first abscissa X1.

In the embodiment shown in FIG. 6, the outer surface of the sectors 30 is smooth.

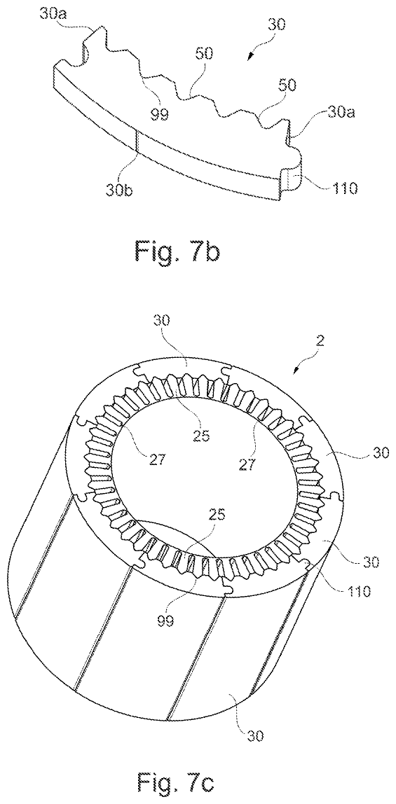

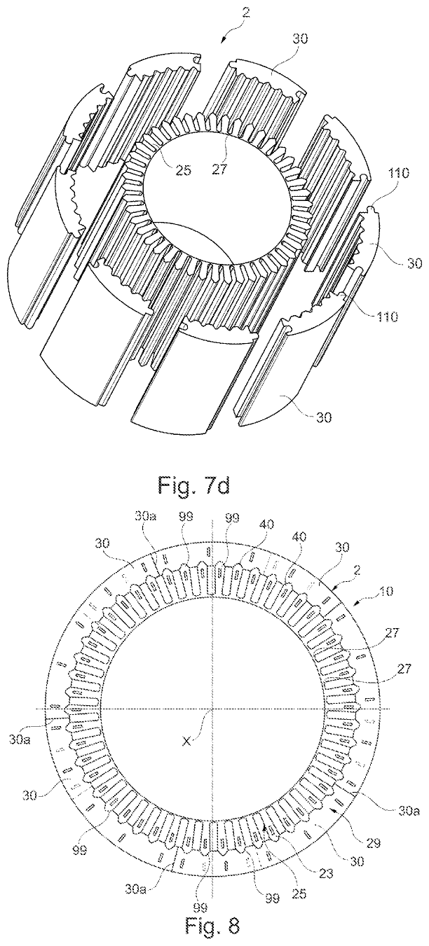

In a variant shown in FIGS. 7 and 7a, the outer surface of the sectors 30 comprises grooves 30b which form a continuation of one another when the sectors are stacked to form the yoke of the stator, thus forming grooves on the outer surface of the yoke. In this embodiment, each sector comprises two grooves. In said embodiment, the sectors are “reversed,” every other sheet.

In a variant shown in FIG. 7b, each sector comprises a single groove 30b. When the sectors are assembled together, it is necessary to drill in order to pass a hard spot, which makes it possible to ensure the coherency of the assembly. The embodiment of FIGS. 7c and 7d differs from the preceding embodiments by the fact that it does not comprise stacked sectors when moving in parallel with the axis of rotation X of the machine. In this example, the yoke is formed of sectors 30 assembled circumferentially and not axially.

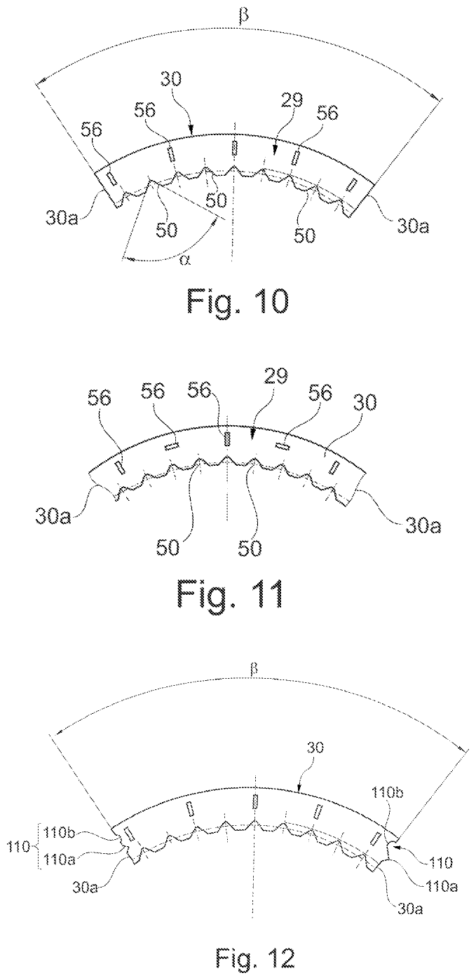

In the variant shown in FIGS. 8 to 10, the interface between the yoke and the ring also forms undulations 99. For this purpose, the first reliefs 40 are in the shape of a boss, and the second reliefs 50 are in the shape of a corresponding recess. In the example described, the second reliefs 50 have an angular opening α of 80°.

In the example described, each sector has an angular extent β of 72°, measured in a transverse plane of the stator, perpendicular to an axis of rotation of the machine, around said axis of rotation. Each sector 30 has the same angular extent.

In this example, the yoke 29 comprises five sectors 30 which are also identical to one another in shape. Each sector cooperates with nine teeth of the ring 25.

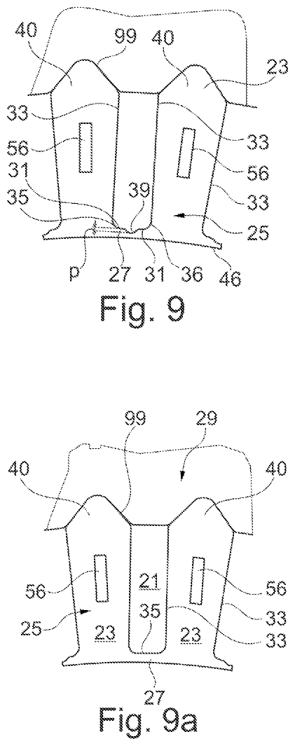

Furthermore, in the example shown, the teeth 23 of the ring 25 comprise complementary surface reliefs 56 which make it possible to clip together the different sheets which make up the ring 25, as can be seen in FIG. 9. In this example of FIG. 9, a complementary relief 56 is present on each tooth. Of course, it would not be a departure for every other tooth to comprise such complementary reliefs, or one tooth in three, or in four, for example. The yoke can also comprise these, as shown in FIG. 8.

Said reliefs 56 can be generally oblong in shape, for example rectangular, and they may have a major axis oriented radially, or, in a variant, oriented circumferentially, as shown in FIG. 11.

The stator may be obtained by means of the production method which will now be described. Following insertion of the coils 22 into the slots 21 of the ring 25 by a radial displacement of the coils 21 towards the inside of the slots 21, all the sectors 30 of the yoke 29 are radially attached simultaneously, according to a radial direction extending in the median plane of the corresponding sector. Each sector may be inserted onto the ring by radial, and not axial, displacement of one relative to the other, by virtue of the planar shape of the interfaces 30a between the sectors 30 and the rippled shape of the interface between the yoke and the ring.

The angular extent of each sector, the shape of the interfaces 30a, and the shape of the interface between the yoke and the ring are selected so as to allow the sectors 30 of the yoke to move closer, radially, on the ring. In one embodiment they are attached simultaneously.

In the example described with reference to FIGS. 1 to 5, the bottom 35 of the slots 21 is of a shape substantially complementary to that of the coils 22, being planar.

In a variant, the bottom of the slots 35 may comprise a localized narrowing formed by at least one groove, as shown in FIG. 9, and in the embodiments of FIGS. 7 to 7d. In this example, the bottom 35 of the slots 21 comprises two planar portions 31 on either side of a recess 39, against which the rectangular coils 22 come to bear. The bottom 35 of the slots 21 is connected to the radial edges 33 by rounded edges 36. The recess 39 is provided in the form of a longitudinal groove extending along the axis of rotation X of the machine, centered on the bottom of the slot 21.

The recess 39 preferably has a depth p of between 0.4 mm and 1 mm, for example 0.6 mm.

In another variant shown in FIG. 9a, the bottom of the slot 21 may not comprise a recess, the bottom 35 of the slots being flat.

In another variant, the bottom of the slot 21 may not comprise a recess, and the pleats may each be formed of a groove turned towards said bottom of the slot 21, and a projecting relief may extend into the air gap 46.

The grooves 48 and projecting reliefs 42 may have a profile in the form of a V-shaped broken line, and the bottom of the slot 21 has a width which reduces towards the projecting relief from the radial edges 33 of the slot 21.

The deformable zone is a zone which may stretch and deform by stretching to form a constriction. When it is stretched, the deformable zone 32 may become thinner locally. Prior to the mounting of the yoke, the bridge of material 27 may have a constant thickness.

The bottom of the slot may comprise two deformable zones 32 as described above.

In this example of FIGS. 8 to 10, the interface between two adjacent sectors 30 is planar, extending in a radial plane.

Two adjacent sectors of the yoke may define, therebetween, an interface extending almost entirely in a substantially radial plane, but not entirely, as shown in FIG. 12. In this example, the sectors comprise reliefs 110 intended to cooperate with corresponding reliefs of the other adjacent sector. The reliefs 110 comprise a triangular part 110a which cooperates in an interlocking manner with the adjacent sector, and a circular part 110b forming an orifice between the two adjacent sectors.

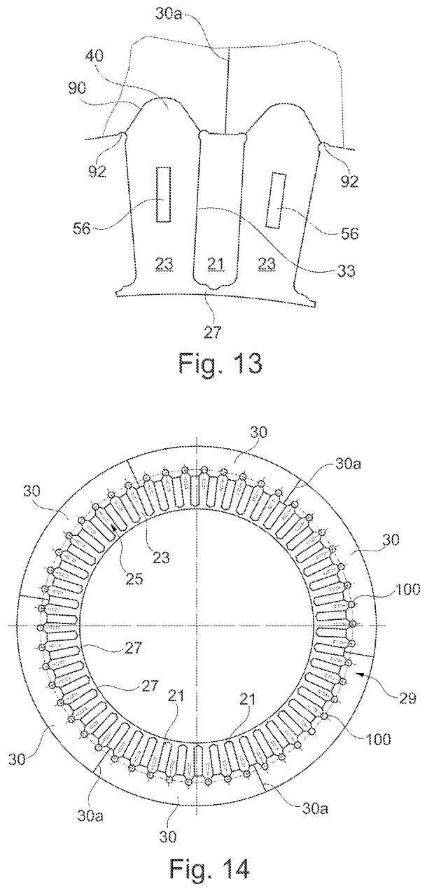

The embodiment of FIG. 13 differs from that of FIGS. 8 to 10 in that the slots of the ring comprise rounded corners 92 close to the yoke.

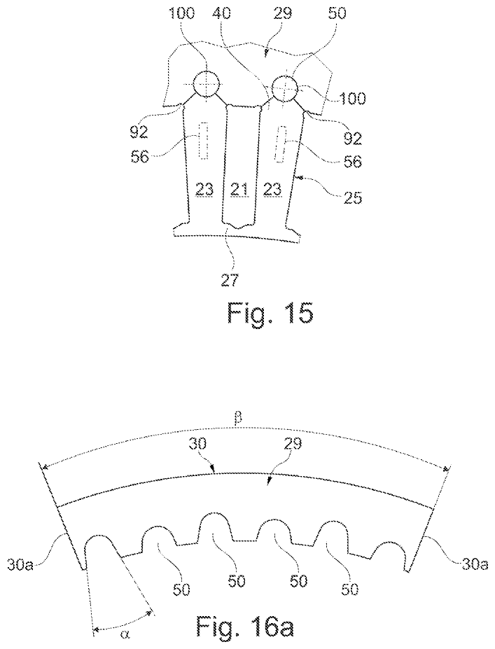

Holes 100 may be arranged at the interface between the ring and the yoke, as shown in FIGS. 14 and 15. These holes 100 make it possible to avoid the presence of sharp edges in the region of the interface. There is a maximum contact between the straight edges on either side of the holes 100.

These holes 100 may serve for passage of a flow of cooling fluid, for example a flow of air, for the cooling of the stator. In a variant, they may serve for passage of tie rods for holding the stator.

In this embodiment, each sector has an angular extent of 60°, measured in a transverse plane of the stator, perpendicular to an axis of rotation of the machine, around said axis of rotation. Each sector 30 has the same angular extent. The sectors 30 of the yoke are also identical to one another in shape. Each sector cooperates with eight teeth of the ring 25.

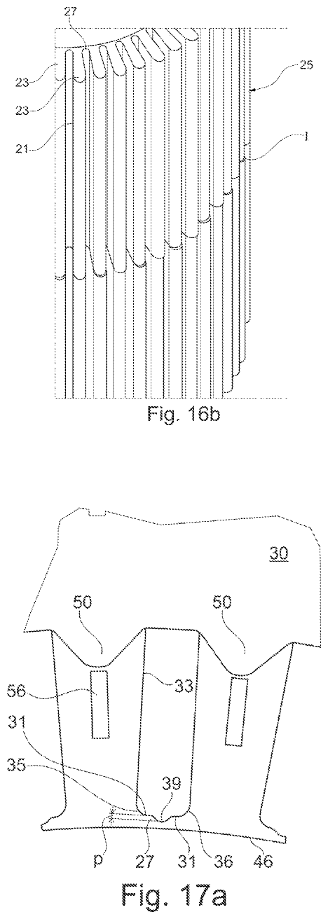

In the variant shown in FIGS. 16a and 16b, the sector of the yoke comprises second reliefs 50, the bottom of which is in the shape of a circular arc. In the example described, the bottom of every other second relief 50 is deeper than the others. Furthermore, every other tooth of the toothed ring shown in FIG. 16b is also longer. There is thus an alternation of two depths at the interface between the yoke and the ring.

Furthermore, at least two sets of sheets, one of which is reversed with respect to the other, are put in place in the pack of sheets. There is thus a resulting offset in the region of the interface I between the assemblies, as can be seen in FIG. 16b.

In a variant, it is also possible to offset the interior ring by one tooth pitch, without forming the reversal.

Thus, when the sectors of the yoke are in place on the toothed ring, an axial blocking due to the presence of said offset is achieved.

Furthermore, said interface I makes it possible to firmly immobilize the toothed ring with respect to the yoke.

The interface I between the assemblies may be located in the center of the pack of sheets, or, in a variant, offset on one side.

Other variants will now be set out.

In the embodiment of FIG. 9, the second relief is oriented towards the yoke.

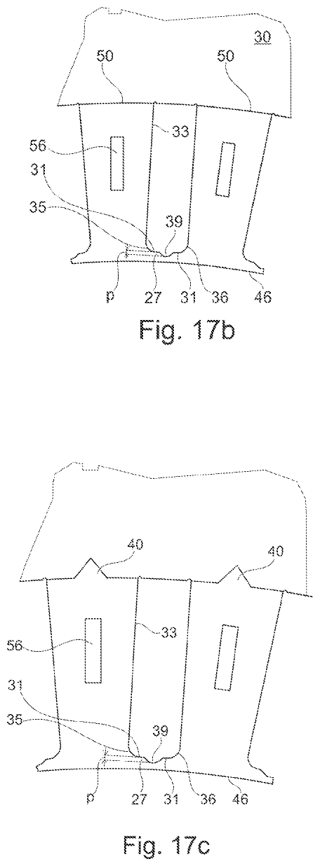

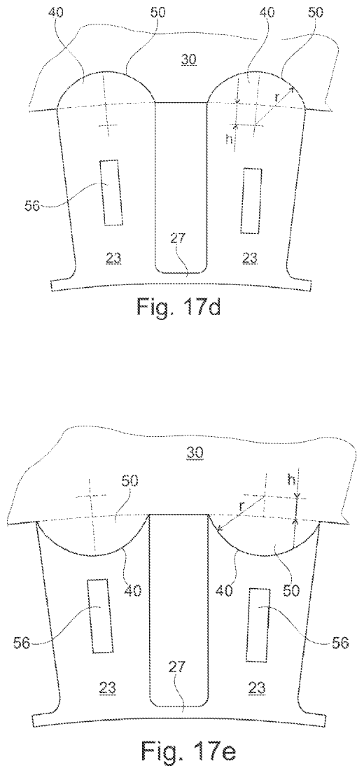

In another embodiment shown in FIG. 17a, the second relief is, in contrast, oriented towards the air gap.

In another embodiment shown in FIG. 17b, the second relief is flat. The angular opening α is α=180°.

In a variant shown in FIG. 17c, the second reliefs have a contour formed of two straight portions forming an angle α therebetween, comprising, on either side, two flat portions at 180°. A point is thus formed for stopping the rotation of the yoke relative to the ring. The point may be oriented towards the yoke, or, in a variant, towards the air gap.

In another variant, as shown in FIGS. 17d and 17a, the second reliefs may have a contour in the shape of a circular arc. The circular arc has a chord separated by a distance h from its center of curvature. The following relationship exists:

|N|≥r·sin(β/2−π/Nenc),

where r is the radius of curvature of the circular arc portion, h is the distance separating the chord of the circular arc from the center of curvature, β is the angular extent of a sector of the yoke, and Nenc is the total number of slots of the stator.

The circular arc may be oriented towards the yoke, as shown in FIG. 17d, or, in a variant, towards the air gap, as shown in FIG. 17e.

The claimed invention is not limited to the described examples of the interface between the sectors of the yoke, and this can be implemented with different shapes again.

1. A stator for a rotary electric machine, comprising:
a radially interior ring comprising teeth and slots opening radially towards the outside and extending between the teeth, bridges of material connecting two adjacent teeth at their base and defining the bottom of the slot between these teeth,
coils arranged in the slots, having electrical conductors arranged in an ordered fashion in the slots, and
a radially outer yoke attached in contact with the ring, the yoke being formed of assembled sectors, the stator comprising an axial stack of axially assembled sectors, a first interface defined between two adjacent sectors located at a first abscissa along the axis of rotation of the machine being angularly offset with respect to a second interface defined between two adjacent sectors located at a second abscissa along the axis of rotation, which abscissa is different from the first abscissa.

2. The stator according to claim 1, the sectors of the yoke each having an angular extent of between 18 and 180°, preferably between 24 and 120°, indeed between 30 and 90°.

3. The stator according to claim 1, the yoke comprising, in cross section, between 2 and 20 sectors, preferably between 3 and 15 sectors.

4. The stator according to claim 1, two adjacent sectors of the yoke defining, therebetween, an interface extending in a substantially radial plane.

5. The stator according to the claim 1, the radial plane of the interface passing through a slot, preferably all the radial planes of all the interfaces of the yoke passing through the slots.

6. The stator according to claim 1, the angular offset being between one and ten teeth, preferably between two and eight teeth.

7. The stator according to claim 1, the sectors of the yoke comprising surface reliefs which make it possible to clip them together.

8. The stator according to claim 1, the ring and the yoke comprising, respectively, first and second reliefs which cooperate with one another and/or with one or more inserts.

9. The stator according to claim 8, the bridges of material comprising zones which are magnetically saturated during the operation of the machine, in particular zones of smaller width.

10. The stator according to claim 1, the coils each comprising at least one electrical conductor which is rectangular in cross section, the coils in particular being arranged in a distributed manner in the slots.

11. A rotary electric machine comprising the stator according to claim 1, and a rotor.

12. A method for producing a stator according to claim 1, wherein sectors are attached radially on the ring to form the yoke in contact with the ring.
